(19) United States
(12) Patent Application Publication
(10) Pub. No.: US 2008/0315083 A1
(43) Pub. Date: Dec. 25, 2008

(54) Device and Method for Coupling Capillary Separation Methods and Mass Spectrometry

(76) Inventors: Dieter Lubda, Bensheim (DE); Ulrich Tallarek, Magdeburg (DE); Erdmann Rapp, Biederitz (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/588,457

(22) PCT Filed: Jan. 25, 2005
(86) PCT No.: PCT/EP2005/000712

§ 371 Date: Aug. 4, 2006

(30) Foreign Application Priority Data
Feb. 5, 2004 (DE) 10 2004 005 888.1

(51) Int. Cl. H01J 49/26; B01L 3/00

(52) U.S. Cl. 250/288; 422/68.1; 422/69

(57) ABSTRACT

The present invention relates to capillaries which are at least partially sheathed with metal foil and to the use thereof in the coupling of methods such as HPLC, CE (capillary electrophoresis), CEC (capillary electrochromatography) or pCEC (pressurised CEC) to MS (mass spectrometry). The sheathing according to the invention with metal foil enables direct coupling of the capillaries to a mass spectrometer without using further adapters, such as spray needles or empty capillary parts.

The present invention relates to capillaries which are at least partially sheathed with metal foil and to the use thereof in the coupling of methods such as cHPLC (capillary HPLC), CE (capillary electrophoresis), CEC (capillary electrochromatography) or pCEC (pressurised CEC) to MS (mass spectrometry). The metal foil sheathing according to the invention enables direct connection of the capillaries to a mass spectrometer without using further adapters, such as spray needles or empty capillary parts.

Liquid chromatography, in particular HPLC, is a very widespread method for the separation of analyte mixtures. Other separation methods, in particular for relatively small sample volumes, are electrophoretic methods, such as capillary electrophoresis (CE) or capillary isotachophoresis, or a combination of electrophoretic and chromatographic methods, as in capillary electrochromatography (CEC) and pCEC. These methods can be carried out in separating columns or separating capillaries or also in miniaturised planar systems, such as microchips. To date, the subsequent analysis has frequently been carried out spectroscopically. In order to overcome this restriction both with respect to the requisite amount of analyte and also with respect to the requirements of the properties of the analytes, it is now increasingly being attempted to combine and couple the said separation methods to mass spectrometric analytical methods, in particular ESI-MS (electrospray ionisation mass spectrometry). This combination opens up the possibility of analysing a large number of samples quickly, with high sensitivity and accuracy and is thus of major interest, especially for biological applications, for example in the area of genome and proteome analysis.

The central problem in combining chromatographic and/or electrophoretic separation methods with mass spectrometric analytical methods lies in the introduction of the relevant parts of the sample into the mass spectrometer. In the ideal case, an additional manual working step should not be necessary for this purpose. Corresponding adapters, so-called interfaces, have therefore been developed which facilitate direct introduction of the sample into the mass spectrometer.

An overview of various interface designs is given, for example, in C. J. Herring and J. Qin, Rapid Communications in Mass Spectrometry, 13, 1-7 (1999).

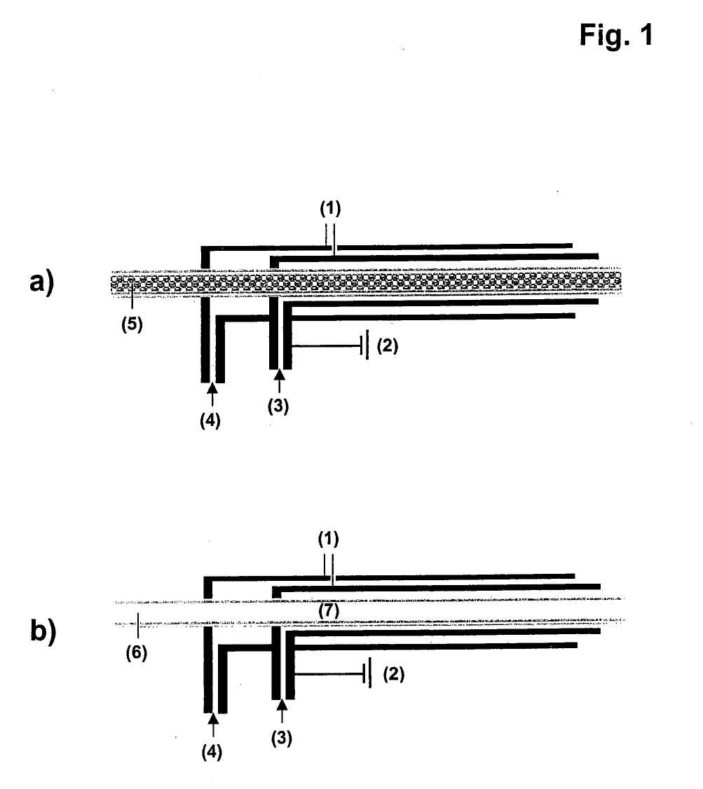

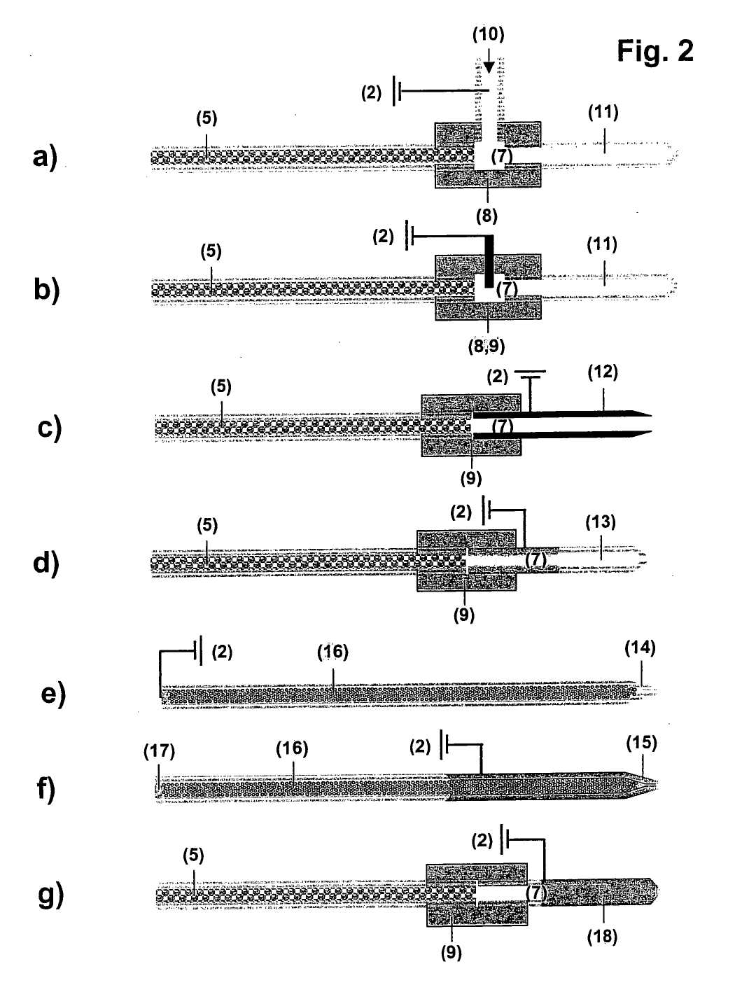

An interface usually consists of a spray needle or an empty capillary which is attached to the separating column or separating capillary. FIGS. 1 and 2 show various possibilities in accordance with the prior art. FIG. 1 shows variants in which the electrical contact for producing the electrospray is ensured via an additional sheath liquid (3) flowing around the capillary column (5) or the fused silica (FS) capillary (6). In FIG. 1a), the spraying is carried out directly from the capillary chromatographic bed. In FIG. 1b), the spraying is carried out directly from an open tubular fused silica (OT-FS) capillary (6), which serves as transfer line from the separating column to the mass spectrometer. With the aid of a nebulisation gas (4) flowing around the two inner capillaries, a very stable spray can be produced, even at relatively high flow rates. However, the dilution of the sample with the sheath liquid and the consequent greatly reduced detection sensitivity are disadvantageous.

FIG. 2 shows possibilities without the use of sheath liquid, which are explained individually in greater detail below:

a) The electrical contact takes place via an OT-FS capillary, which is connected via a T-piece (8) between the separating capillary (5) and OT-FS ESI needle (11), where it feeds the “make-up” flow (10).

b) The electrical contact takes place via an electrode, which is connected via a T-piece (8) between the separating capillary (5) and OT-FS ESI needle (11). The connector (9) itself can also serve as electrode.

c) The electrical contact takes place directly via an open stainless-steel (OT-SS) capillary (7), which is connected to the separating capillary (5) via a connector (9). The spray end may also be pointed externally.

d) The electrical contact takes place via an OT-FS ESI needle having an electrically conductive coating at the back end (13), where it is connected to the separating capillary (5) via a connector (9).

e) The electrical contact takes place at the column inlet, i.e. well above (upstream of) the spray end of the FS capillary column (16) packed into the integrated ESI tip (14).

f) The electrical contact takes place via an electrically conductive coating at the spray end of the FS capillary column (16) packed into the integrated ESI tip (15).

g) The electrical contact takes place via an electrically conductive coating at the spray end of an OT-FS ESI needle (18), which is connected to the separating capillary (5) via a connector (9).

It is disadvantageous in variants 2a to d and g that the connected empty capillary creates an additional dead space (7), which impairs the quality of the prior separation.

In FIG. 2e, the electrical contact is made as early as the inlet of the separating capillary, causing the actual voltage ultimately present at the electrospray tip to react to changing conductivities of the mobile phase (for example during gradient elution) to an even greater extent than in the case of variants 2a to d.

In addition, electrode redox processes in the capillaries may result in the evolution of gas and thus in the formation of bubbles, which may in turn result in electrospray instabilities. Variant 2e is again affected to a particularly great extent by this.

FIGS. 2f and 2g show forms in which filled or unfilled spray needles are provided with a conductive coating at the tip. The voltage present at the electrospray tip is thus independent of the conductivity of the mobile phase. The redox processes take place outside the capillary. Whereas the variant in accordance with FIG. 2g again has the problem of the additional dead space (7), this is avoided in FIG. 2f. Although the embodiment in accordance with FIG. 2f thus exhibits very advantageous properties with respect to the spray behaviour and the sensitivity, it is, however, complicated to produce and has an only short life. The capillary first has to be packed and provided with a sintered inlet frit (17), and the capillary can subsequently be provided with a conductive coating at the tip. This must be carried out without destroying the separating material in the capillary. To date, the coating is therefore applied by, for example, spraying or vapour deposition. The layers formed in this way are very thin and exhibit only limited durability. Processes for the production of more durable layers would attack the separating material or the frit. As soon as the coating becomes faulty, the entire capillary column has to be replaced, since the coating is applied directly to the capillary column. This variant is thus both complex to produce and also not very durable.

The object of the present invention was therefore to develop a possibility for the direct connection of the separating columns or separating capillaries for carrying out chromatographic and/or electrophoretic separation methods to MS instruments. Both dead spaces and also dilution of the sample with sheath liquids should be avoided here. Furthermore, the connection should be simple to make and have a long life.

It has been found that these requirements are met by a column or capillary which is at least partially sheathed with metal foil at one end. The use of a capillary containing a monolithic sorbent is particularly advantageous. The preferred direct sheathing of the separating capillary obviates the need for an additional spray needle or an empty capillary. In this way, dead spaces are avoided. It has been found that covering of the capillaries with metal foil is sufficient. Complex coating by spraying or sputtering is not necessary. The sheathing is very durable and can be replaced at any time without major effort, without having to discard the entire separating capillary.

The present invention therefore relates to a capillary which is at least partially sheathed with metal foil at one end.

In a preferred embodiment, the metal foil is a gold foil.

In a preferred embodiment, the capillary is filled with sorbent.

In a preferred embodiment, the sorbent is a monolithic sorbent.

In a particularly preferred embodiment, the sorbent is an inorganic monolithic sorbent.

In a preferred embodiment, in the case of capillaries which are empty or filled with particulate sorbents, the capillary end sheathed with metal foil is tapered both externally and internally and forms a fine tip.

In a further preferred embodiment, in the case of capillaries which are filled with monolithic sorbents, the capillary end sheathed with metal foil is tapered externally, with the outside diameter of the capillary decreasing towards the end and the internal diameter of the capillary tube remaining the same.

The present invention also relates to a device for coupling capillary separation methods to mass spectrometric analytical instruments, at least having a capillary for carrying out the separations and a mass spectrometric analytical instrument, characterised in that the capillary is at least partially sheathed with metal foil at the end facing the mass spectrometric analytical instrument.

In a preferred embodiment, the capillary is filled with a monolithic sorbent.

The present invention also relates to a method for the direct coupling of instruments for carrying out capillary separations to mass spectrometric analytical instruments, characterised in that the coupling takes place via a capillary which is at least partially sheathed with metal foil at the end facing the mass spectrometric analytical instrument.

The present invention also relates to the use of capillaries which are at least partially sheathed with metal foil at one end for producing electrospray for the introduction of analytes into an ESI-MS instrument.

FIGS. 1 and 2 show various possibilities of an interface in accordance with the prior art.

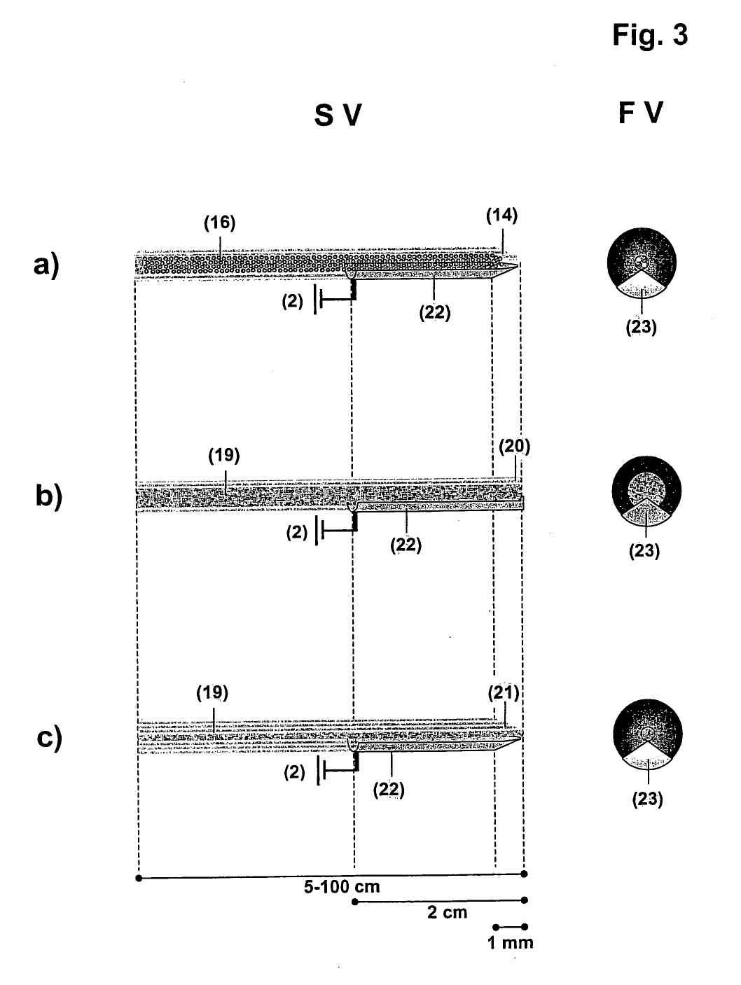

FIG. 3 shows three different embodiments of a capillary according to the invention. The dimensions of the capillary columns are shown in Table 1.

a) Capillary column packed with particulate material. The electrical contact takes place via a gold foil (22) applied directly to the spray end of the FS capillary column (16) packed into the integrated ESI tip (14).

b) Monolithic capillary column (19). The electrical contact takes place via a gold foil (22) applied directly to the spray end of the monolithic FS capillary column cut off at right angles (20).

c) Monolithic capillary column (19). The electrical contact takes place via a gold foil (22) applied directly to the externally pointed spray end of the monolithic FS capillary column (21).

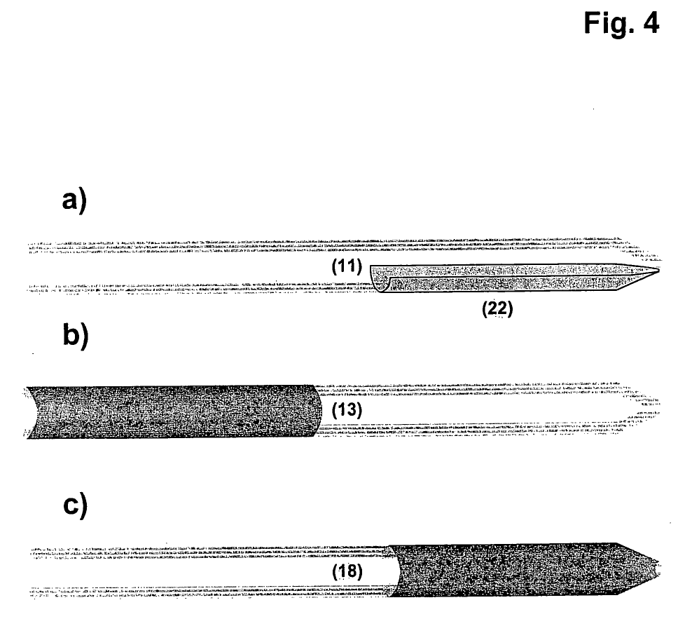

More detailed explanations of FIGS. 4 to 7 are given in Examples 1 and 2. In the drawings, reference numbers 1 to 22 are to be assigned to the following terms:

(1) Stainless-steel capillary (SS)

(2) High-voltage source (HV)

(3) Sheath liquid

(4) Sheath gas

(5) Capillary column

(6) Open tubular fused silica (OT-FS) capillary as transfer line

(7) Dead space

(8) T-piece

(9) Connector

(10) Make-up flow

(11) OT-FS ESI needle

(12) OT-SS ESI needle

(13) Distal end coated OT-FS ESI needle

(14) Integrated ESI needle

(15) Tip-end coated integrated ESI needle

(16) Capillary column packed into the tip

(17) Sintered inlet frit

(18) Tip end coated OT-FS ESI needle

(19) Monolithic capillary column

(20) End cut off at right angles

(21) Integrated ESI needle (pointed externally)

(22) Gold foil applied directly to the ESI tip

(23) Arrowhead of gold foil

In accordance with the invention, capillary separation methods are taken to mean chromatographic, electrophoretic, isotachophoretic and/or electrochromatographic separations or separation methods, in particular liquid chromatographic methods, such as HPLC, micro- or nano-HPLC, and CE (capillary electrophoresis), CEC (capillary electrochromatography) or pCEC (pressurised CEC). Chromatographic, electrophoretic, isotachophoretic and/or electrochromatographic methods which are carried out in miniaturised systems, such as planar microstructured systems or chips, furthermore also count amongst these.

For the purposes of the invention, capillaries are taken to mean columns or tubes in which the above-mentioned capillary separation methods can be carried out. In accordance with the invention, the term capillary also covers capillary parts, tubes or needles which can be attached to other tubes or capillaries.

The capillaries are typically made of glass, fused silica, plastic (for example polyimide)-coated glass or fused silica, other ceramic or glass-like materials, plastic (for example fluoropolymers, polyolefins, polyketones, such as, in particular, polyether ketones (preferably PEEK), acrylates, polyamides or polyimides) or fibre-reinforced plastic. In preferred embodiments, the capillaries consist of plastic-coated fused silica. Capillaries are furthermore taken to mean tubular or channel-like structures in microstructured components, such as, for example, planar microchips, which project out of the component at least at one end in the form of a tube, needle or capillary.

Both the cross section of the cavity located in the capillary and the outside cross-section of the capillary preferably have a circular shape. However, the cross section may also have any other shape, for example an oval, square, rectangular or polygonal shape.

The internal diameter of the capillary is typically between 1 μm and 5 mm, preferably between 10 and 100 μm. The preferred diameters vary depending on the type of capillary and the flow rate desired for the separation. The internal diameter preferably remains constant over the entire length of the capillary. However, embodiments in which the internal diameter changes, in particular towards the end of the capillary, i.e., for example, becomes smaller as in a conical shape and the capillary tapers as to a tip, are also possible. This embodiment is also referred to below as internally tapered or an internal cone. The diameter of the capillary usually tapers by a factor of 2-10 over a length of 1-2 mm.

The outside diameter of the capillaries is typically also constant. In a preferred embodiment, however, the capillary end sheathed with metal foil is pointed, i.e. the outside diameter decreases towards the end of the capillary, so that a tip is formed. This embodiment is also referred to below as externally tapered or an external cone.

Depending on the type of capillary, various designs of the capillary end may be advantageous. In the case of empty capillaries or capillaries filled with particulate sorbents, an internally and externally tapered end has proven advantageous. In the case of capillaries filled with monolithic sorbents, this additional complexity is not necessary. On use of monolithic sorbents, a very good spray behaviour is even evident in the case of capillaries having a constant internal and outside diameter. In some cases, it may be advantageous here for the capillary to be pointed externally, thus producing an external cone.

The internal and outside diameter at the end of the capillary at which the electrospray is produced is of particular importance. This end is also called tip below.

Preferred internal diameters (ID) and outside diameters (OD) are indicated below for various types of capillary and certain flow rates:

Empty Capillaries:

Tip ID: 5-30 μm (8-15 μm is ideal in the case of flow rates of 100-350 nl/min)

Tip OD: as small as possible

Sorbent-Filled Capillaries:
Packed with particulate sorbents, the end of the capillary tapered internally and externally:
Tip ID: 10-25 μm (in the case of flow rates<500 nl/min)
Tip OD: as small as possible

Containing monolithic sorbent, constant internal diameter:
ID: 50-100 μm (in the case of flow rates>500 nl/min)
OD: as small as possible or preferably externally pointed capillaries
ID: 10-50 μm (in the case of flow rates<500 nl/min)
OD: as small as possible or preferably externally pointed capillaries.

On use of capillaries containing monolithic sorbents, IDs<50 μm are in principle advantageous since the ideal flow rates for these monolithic capillaries also correspond to those for micro- and nanoelectrospray. It is also advantageous for the ionisation efficiency to synthesise the monolithic sorbents directly in capillaries having an internal and/or external cone. An external cone can also easily be produced subsequently on the capillary filled with monolithic sorbent.

The length of the capillaries according to the invention varies depending on the type of capillary. The capillary can be a short needle or tip, for example for attachment to other capillaries or columns. In this case, the length is typically 1 cm to 20 cm. The capillary can equally be a separating capillary. In this case, the length is typically between 2 and 200 cm.

Otherwise, the dimensions of the capillaries according to the invention correspond to the usual dimensions in the prior art.

The capillaries according to the invention may be empty, fully or partially coated on the inside or fully or partially filled with sorbent. The capillaries according to the invention are preferably filled with sorbent. If the capillary is filled with particulate sorbents, it additionally generally has a frit, a sieve or a filter at the end in order to immobilise the sorbent in the capillary.

A sorbent is a material on which capillary separations can be carried out. It is typically a solid phase comprising inorganic and/or organic, particulate or monolithic materials. Suitable organic materials are, for example, particles or monolithic materials which are produced, for example, by free-radical, ionic or thermal polymerisation. They can be, for example, poly(meth)acrylic acid derivatives, polystyrene derivatives, polyesters, polyamides or polyethylenes. The monomers to be employed correspondingly are known to the person skilled in the art in the area of organic polymers. For example, these are monoethylenically or polyethylenically unsaturated monomers, such as vinyl monomers, vinyl-aromatic and vinyl-aliphatic monomers, for example styrene and substituted styrenes, vinyl acetates or vinyl propionates, acrylic monomers, such as methacrylates and other alkyl acrylates, ethoxymethyl acrylate and higher analogues, and the corresponding methacrylic acid esters or amides thereof, such as acrylamide or acrylonitrile. Further monoethylenically and polyethylenically unsaturated monomers are found, for example, in EP 0 366 252 or U.S. Pat. No. 5,858,296.

Suitable inorganic materials are, for example, particulate or monolithic materials made of glass, ceramic, inorganic oxides, such as aluminium oxide, zirconium dioxide or titanium dioxide, or preferably of silica materials (silica gel).

The sorbent may furthermore consist of organic/inorganic hybrid materials. These are, for example, inorganic materials which have been provided with an organic coating. They may furthermore be inorganic/organic copolymers. For example, in the case of silica-based materials, organoalkoxysilanes having one to three organic radicals can be employed instead of the tetra-alkoxysilanes producing purely inorganic materials.

Particulate sorbents may consist of uniformly or non-uniformly shaped porous or nonporous particles.

Monolithic sorbents consist of porous mouldings. The pore distribution can be mono-, bi-, tri- or polymodal. They are typically materials having a mono- or bimodal pore distribution.

All sorbents may in addition be modified with separation effectors in order to effect certain separation properties.

Particular preference is given in accordance with the invention to the use of capillaries containing monolithic sorbents, particularly preferably containing inorganic monolithic sorbents. It has been found that a particularly uniform and fine electrospray can be produced from capillaries containing monolithic sorbents.

Preference is therefore given to the use of monolithic materials having macropores having a mean diameter of greater than 0.1 μm, preferably between 1 μm and 10 μm. In a particularly preferred embodiment, these materials additionally contain mesopores having a diameter of between 2 and 100 nm. WO 99/38006 and WO 99/50654 disclose processes for the production of capillaries filled with monolithic silica material. WO 95/03256 and particularly WO 98/29350 also disclose processes for the production of inorganic monolithic mouldings by a sol-gel process.

One reason for the particularly stable and fine electrospray on use of the monolithic materials could be their particular pore structure, since the effect is observed in particular in the case of monolithic materials having macroporous through-flow pores.

An MS instrument which is suitable in accordance with the invention is a mass spectrometer into which the sample is introduced in the form of an electrospray. This is thus typically a mass spectrometer with an ESI and/or nano-ESI source.

For the purposes of the invention, the term metal foil is used for a foil of conductive metal or metal alloys. For processability reasons, the thickness of the foil is generally greater than 10 μm, typically between 20 and 100 μm. In the case of gold, the preferred thickness is, for example, between 10 and 50 μm. Suitable metals are those which can be produced and processed as a foil in the suitable thickness and are electrically conductive. Examples thereof are:
gold
aluminium
platinum
titanium
palladium
silver
   Also suitable are alloys of and/or comprising one or more of these metals and other alloys, such as, for example, stainless steels.

Preference is given in accordance with the invention to the use of gold foil. Alfa Aesar gold foil has proven particularly suitable; 25×25 mm, 0.025 mm thick, Premion®, 99.985% (metals basis).

The length and width of the metal foil employed for the sheathing are dependent on the particular capillary and also on the MS instrument employed. In general, the capillary has at one end a sheathing with metal foil which covers the outside of the capillary over a length of at least 3 mm, typically between 5 mm and 10 cm, starting from the end of the capillary. The capillary here may be completely surrounded by the foil or alternatively only partly. Typically, at least ⅙ of the circumference of the capillary is covered. Preferably, ¼ to half of the circumference of the capillary is covered. The embodiments shown in FIG. 3 have, for example, a sheathing in which half of the circumference is covered by foil. It is important that the liquid phase in the capillary is in contact with the metal foil. The separation of the metal foil from the end of the capillary, i.e. the liquid outlet or the cavity of the capillary, should therefore typically be not greater than about 50 μm. On the other hand, particularly in the case of small diameters at the end of the capillary, the foil must not significantly change the geometry at the outlet of the capillary. Otherwise, a stable and uniform spray cannot be produced. In order to ensure these requirements, the ideal shape of the metal foil can be selected. The shape of the metal foil can be square, rectangular, triangular, round, oval, polygonal, etc. In order to produce an ideal electrospray, shapes in which the foil tapers towards the capillary tip, so that the tip of the foil reaches the tip of the capillary, have proven advantageous.

One possible embodiment is shown in FIG. 3. Here, with a capillary (14, 21) tapered at the end, the foil is also tapered towards the end and placed around the capillary like a boat, so that the tip of the metal foil (23) comes to rest directly against the edge of the capillary end. In the case of capillaries whose diameter does not change towards the end (20), the foil is preferably slightly folded around the end of the capillary, so that it covers the thickness of the wall of the capillary and extends as far as the inner cavity.

The metal foil is fixed, for example, by warming, adhesive bonding or with the aid of a fixing, for example in the form of a plastic sheath or ring.

FIG. 3 shows three possible embodiments of the capillary according to the invention. In this case, gold foil was used in each case for contact connection. SV denotes the side view of the capillaries, FV the front view of the capillary tip.

FIG. 3a) shows an embodiment in which a capillary which is tapered internally and externally (shaped corresponding to a nano-ESI needle) is filled with particulate sorbent (16). The gold foil (22) surrounds half of the end of the capillary and tapers towards the tip of the capillary (23), so that it is in direct contact with the end of the capillary, but does-not project significantly into the cavity or channel of the capillary. The geometry of the exit aperture is thus not impaired.

More precise details of the dimension of the capillary and the gold foil are given in Table 1.

FIG. 3b) shows a capillary containing monolithic sorbent (19), the end of which is cut off cleanly and does not taper to a tip (20). The gold foil (22) surrounds half of the end of the capillary and is slightly folded around the edge of the capillary (23), so that it is in direct contact with the aperture of the capillary, but does not project to a great extent into the cavity or channel of the capillary. The geometry of the exit aperture is thus not impaired.

More precise details of the dimension of the capillary and the gold foil are given in Table 1.

FIG. 3c) shows a capillary containing monolithic sorbent (19), the end of which tapers externally (21). The gold foil (22) surrounds half of the end of the capillary and tapers towards the tip of the capillary (23), so that it is in direct contact with the end of the capillary, but does not project significantly into the cavity or channel of the capillary. The geometry of the exit aperture is thus not impaired.

More precise details of the dimension of the capillary and the gold foil are given in Table 1.

TABLE 1

| Embodiment | 3a) | 3b) | 3c) |
|---|---|---|---|
| Outside diameter of the capillary [μm] | 365 | 165 | 365 |
| Internal diameter of the capillary [μm] | 20-250 | 20-100 | 20-250 |
| Internal diameter (ID) of the tip [μm] | 5-30 | 20-100 | 20-250 |
| Outside diameter of the tip [μm] | ID + 10 | 165 | =ID |
| Length of the gold foil [cm] | 2 | 2 | 2 |
| Width of the gold foil [μm] | 570 | 260 | 570 |
| Thickness of the gold foil [μm] | 25 | 25 | 25 |

| | |
|---|---|
| Shape of the gold foil | Arrowhead |

The capillary sheathed with metal foil in accordance with the invention is, if prior separation of the analytes is desired, employed in a known manner for the separation of analytes. It can equally be employed for offline nano-ESI measurement, i.e. measurement without prior separation. For coupling to the MS instrument, a voltage is applied to the metal foil, as in the case of other spray needles, so that an electrospray is formed. Using the capillaries according to the invention, a stable spray can be produced at flow rates of between 50 nl/min and 5 μl/min. Suitable flow rates here are between 50-1000 nl/min, preferably between 200-300 nl/min, for tip internal diameters of about 10 μm. Suitable flow rates are between 0.5-5 μl/min, preferably between 1-2 μl/min, for tip internal diameters of about 100 μm. In the case of embodiments containing monolithic sorbents, even higher flow rates, i.e. >5 μl/min, for example 10-20 μl/min, can be produced in the case of internal diameters of about 100 μm. In addition, capillaries containing monolithic sorbents exhibit greater flow-rate variance.

At flow rates of <500 nl/min, the separation of the capillary from the MS instrument inlet should be about 3-10 mm. At flow rates>500 nl/min, the separation should be about 7-25 mm.

The ideal MS mode and voltage are dependent on the tip ID, tip OD, the flow rate, the tip [symbol] orifice (MS instrument inlet) separation and also on the type of eluent to be sprayed (for example dielectric constant, conductivity, surface tension, viscosity, vapour pressure). All these parameters must be matched to one another.

For nano-ESI mode, voltages of between 1600 and 2300 V are generally suitable. For normal ESI mode, voltages of between 2800-5500 V are generally suitable.

Suitable eluents are known from the prior art for this type of application. The eluent should preferably consist of more than 98% of a mixture of deionised water and methanol, ethanol, propanol and/or acetonitrile. Electrolytic additives (acids, bases, buffers) should also be of a volatile nature (for example formic acid, acetic acid, ammonia, secondary and tertiary amines, ammonium formate, ammonium acetate, ammonium hydrogencarbonate).

The capillaries according to the invention are distinguished by very long durability. Should the metal foil nevertheless be damaged, it can be removed easily and replaced by a new foil. It is not necessary here to replace the separating capillary as well. In the case of capillaries containing monolithic sorbents, the damaged end of the capillary can, if necessary, easily be cut off (and if necessary re-pointed), and the newly produced end re-sheathed with the same metal foil.

The capillary according to the invention is thus simple to produce and use. Damaged parts can be replaced without having to renew the entire capillary. As can be seen from Example 1, the capillaries according to the invention have a very long life. A stable spray can be produced. Random electrical arcing and a number of pauses also have virtually no effect on the stability.

Further advantages, in particular of the preferred embodiments, over the prior art are:
Since the spray is preferably produced directly from the separating capillary, no additional dead spaces are formed by attached spray needles.
No electrode redox processes take place in the capillary.
The field strength at the end of the capillary (ESI tip) is constant.
No dilution with sheath liquid takes place.
Very low flow rates can be used, enabling smaller droplets to form and in addition the capillary end to be brought closer to the MS instrument orifice. The ionisation efficiency and the ion sampling rate can thus be significantly increased.

The capillary according to the invention thus represents a valuable improvement for coupling chromatographic, electrophoretic, electrochromatographic and/or isotachophoretic separation methods to MS.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application DE 10 2004 005 888.1, filed on May 2, 2004, is incorporated into this application by way of reference.

### EXAMPLES

1. Stability of the Electrospray

For comparison of the stability and life of the device and capillary according to the invention with known and commercially available systems, capillaries according to the invention were compared with fused silica needles from the New Objective company. As far as can be ascertained, the New Objective needles are vapour-deposited with gold or a gold alloy.

Further data on the capillaries employed and the experimental procedure are given in Table 2.

TABLE 2

| Figure | 4a | 4b | 4c |
|---|---|---|---|
| ESI needle | Made of fused | Made of fused | Made of fused |
| | silica, tip end | silica, distal end | silica, tip end |
| | sheathed with | vapour-deposited | vapour-deposited |
| | gold foil | | |
| New Objective | FS 360-20-10 N | FS 360-20-10 D | FS 360-20-10 CE |
| Order No. | (not vapour- | | |
| | deposited) | | |
| Capillary OD | 360 | 360 | 360 |
| [μm] | | | |
| Capillary ID | 20 | 20 | 20 |
| [μm] | | | |
| Tip ID | 10 | 10 | 10 |
| [μm] | | | |
| Elect. contact | Gold foil | Metal vapour | Metal vapour |
| by | | deposition | deposition |

| | |
|---|---|
| Capillary | Open tubular OT |
| Mobile phase | 49.95% of methanol/49.95% of water/0.1% of formic |
| | acid |
| Flow rate | 300 nl/min |
| Voltage | 1800 V |
| MS instrument | QSTAR XL ™ from Applied Biosystems MDS SCIEX |

FIG. 4a shows the capillary according to the invention employed. It consists of fused silica (11), has the same geometry as the capillaries from the prior art and is sheathed at the end with an arrow-shaped gold foil (Alfa Aesar gold foil; 25×0.57 mm, 0.025 mm thick, Premion®, 99.985% (metals basis)), i.e. the electrical contact takes place via a gold foil applied directly to the spray end of the ESI tip, tapered internally and externally there, of the OT-FS needle (22).

FIG. 4b shows a capillary in accordance with the prior art, the back end of which is sputtered with gold (13), i.e. the electrical contact takes place via a conductive coating (metal vapour deposition) at the stub back end of the OT-FS ESI needle.

FIG. 4c shows a capillary in accordance with the prior art, the tip of which is sputtered with gold (18), i.e. the electrical contact takes place via an electrically conductive coating (metal vapour deposition) at the spray end of the ESI tip, tapered internally and externally there, of the OT-FS needle.

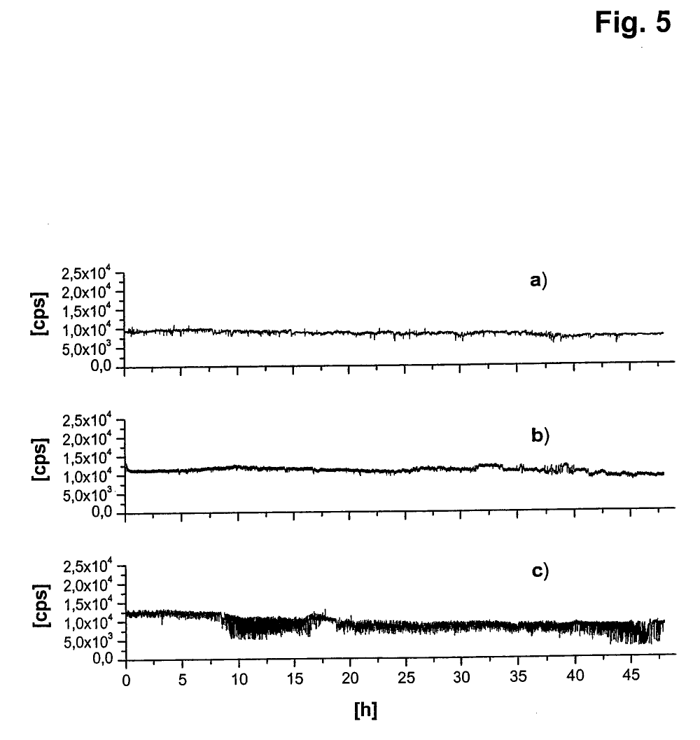

FIG. 5 shows a comparison of the spray properties of the three capillaries (a, b and c corresponding to FIG. 4). The y axis shows the total ion current in cps (counts per second), the x axis shows the time in hours (h). It can be seen that capillaries a) and b) produce a stable spray over 48 hours, whereas capillary c) exhibits irregularities after only 8 hours. Capillary a) according to the invention was used for a further 2000 hours after this experiment and still showed no loss in quality.

2. Comparison of Monolithic/Particulate Sorbents

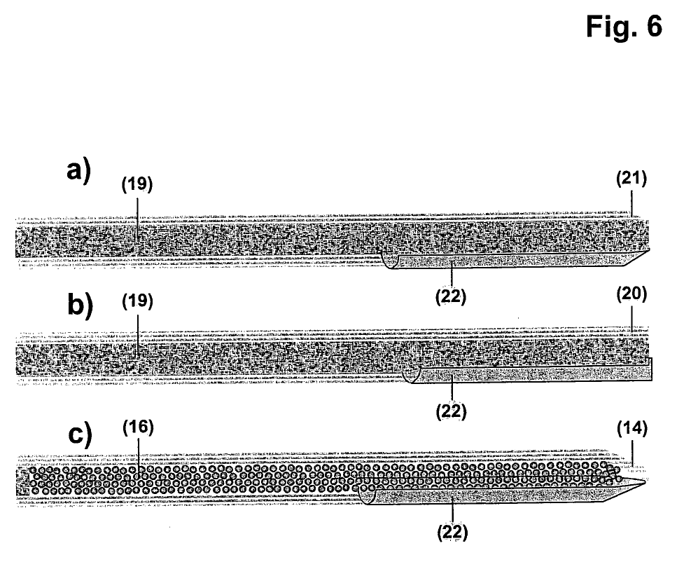

FIG. 6 shows the construction of the three capillaries according to the invention whose spray properties have been compared.

a) Monolithic capillary column (19). The electrical contact takes place via a gold foil (22) applied directly to the externally pointed spray end of the monolithic FS capillary column (21).

b) Monolithic capillary column (19). The electrical contact takes place via a gold foil (22) applied directly to the spray end of the monolithic FS capillary column cut off at right angles (20).

c) Capillary column packed with particulate material (19). The electrical contact takes place via a gold foil (22) applied directly to the spray end of the FS capillary column packed into the integrated ESI tip (14).

Further data on the capillaries employed and the experimental procedure are given in Table 3.

TABLE 3

| Figure | 6a | 6b | 6c |
|---|---|---|---|
| Capillary | Monolithic | Monolithic | Packed |
| column | capillary column | capillary column | capillary column |
| | sheathed with | sheathed with | sheathed with |
| | gold foil | gold foil | gold foil |
| Tip shape | Pointed | Cut off | Tapered |
| | externally | straight | externally and |
| | | | internally |
| Capillary | 365/100 | 164/100 | 365/100 |
| OD/ID [μm] | | | |
| Tip OD/ID | 100/100 | 164/100 | 50/30 |
| [μm] | | | |
| Stationary | Chromolith ™ | Chromolith ™ | Purospher ™ |
| phase | CapRod RP-18e | CapRod RP-18e | STAR |
| | | | RP-18 3 μm |
| Elect. contact | Arrow-shaped gold foil | | |
| by | | | |
| Capillary | Held with sorbent, 25 cm long | | |
| Mobile phase | 49.95% of acetonitrile/49.95% of water/0.1% of formic | | |
| | acid | | |
| Flow rate | 500 nl/min | 1000 nl/min | 300 nl/min |
| Tip [symbol] orifice | 7 mm | 15 mm | 5 mm |
| separation | | | |
| ESI mode | Nano | Normal | Nano |
| Voltage | 2350 v | 3700 v | 1750 v |

| | |
|---|---|
| MS instrument | QSTAR XL ™ from Applied Biosystems MDS SCIEX |

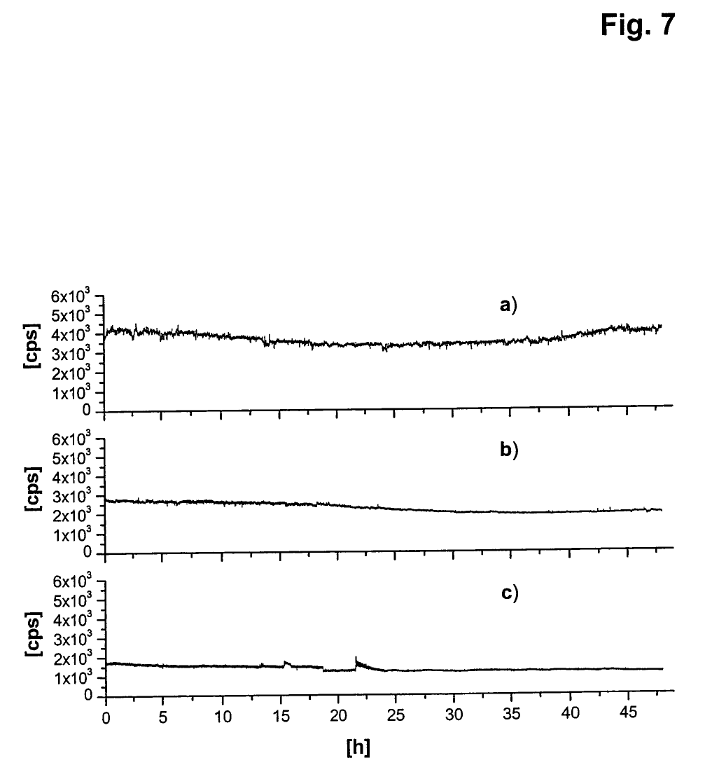

FIG. 7 shows a comparison of the spray properties of the three capillaries (a, b and c corresponding to FIG. 6). The experimental conditions are shown in Table 3. The y axis shows the total ion current in cps (counts per second), the x axis shows the time in hours (h). It can be seen that a monolithic capillary (FIGS. 6b) and c)), even without an internally reducing diameter, has similarly good spray properties to the spray needle filled with particulate sorbent (FIG. 6a)). All three embodiments (FIG. 6a)-c)) exhibit better spray properties than the prior art (see FIGS. 5b) and c)). The differences between the three capillary columns lie in the flow-rate range possible with them (dependent on the tip OD/ID) in which a stable electrospray is possible. This also affects the ionisation efficiency and the ion sampling rate, both of which are higher at lower flow rates. In addition, the possible composition of the mobile phase is increasingly restricted with increasing flow rate (without suitable additional sheath flow).

1. Capillary, characterised in that the capillary is sheathed with metal foil, at least at one end.

2. Capillary according to claim 1, characterised in that the metal foil is a gold foil.

3. Capillary according to claim 1, characterised in that the capillary is filled with sorbent.

4. Capillary according to claim 3, characterised in that the sorbent is a monolithic sorbent.

5. Capillary according to claim 4, characterised in that the sorbent is an inorganic monolithic sorbent.

6. Capillary according to claim 4, characterised in that the capillary end sheathed with metal foil is pointed externally.

7. Capillary according to claim 1, characterised in that the capillary is empty or is filled with particulate sorbent, and the end sheathed with metal foil is tapered internally and externally.

8. Device for coupling capillary separation methods to mass spectrometric analytical instruments, at least having a capillary for carrying out the separations and a mass spectrometric analytical instrument, characterised in that the capillary is sheathed with metal foil, at least at the end facing the mass spectrometric analytical instrument.

9. Device according to claim 8, characterised in that the capillary is filled with a monolithic sorbent.

10. Method for the direct coupling of instruments for carrying out capillary separations to mass spectrometric analytical instruments, characterised in that the coupling takes place via a capillary which is sheathed with metal foil, at least at the end facing the mass spectrometric analytical instrument.

11. Use of capillaries which are sheathed with metal foil, at least at one end, for producing electrospray for the introduction of analytes into an ESI-MS instrument.
